(19) United States
(12) Patent Application Publication
(10) Pub. No.: US 2017/0037661 A1
(43) Pub. Date: Feb. 9, 2017

(54) LOCK AND/OR LATCH MECHANISM

(71) Applicant: Thomas Gerald Tessier, Spring Valley, WI (US)

(72) Inventor: Thomas Gerald Tessier, Spring Valley, WI (US)

(21) Appl. No.: 15/227,109

(22) Filed: Aug. 3, 2016

Related U.S. Application Data
(60) Provisional application No. 62/282,567, filed on Aug. 4, 2015.

(51) Int. Cl. E05B 77/34; E05B 17/20; E05C 3/04; E05B 17/08; E05B 83/34

(52) U.S. Cl. CPC E05B 77/34; E05B 17/08; E05B 83/34; E05C 3/04; E05B 17/2011

(57) ABSTRACT

A lock and/or latch mechanism invention comprises a tumbler having a distal end, the distal end having a receiver and a hole disposed through the receiver and a grease zerk fitting being engaged to the receiver, the grease zerk fitting being constructed and arranged to establish a grease passage through the grease zerk fitting into the interior of the tumbler.

### CROSS-REFERENCE TO RELATED APPLICATIONS

This application claims the benefit of U.S. Provisional Patent Application Ser. No. 62/282567 filed Aug. 4, 2015, which is incorporated by reference herein in its entirety.

### FIELD OF THE INVENTION

The present invention in general relates to improving the reliability and longevity of locks and/or latches, particularly when the locks and/or latches are exposed to moisture or extreme weather conditions for extended periods of time.

### BACKGROUND OF THE INVENTION

In the past locks and/or latches have been used within environments where the locks and/or latches have been exposed to moisture or water occurring from condensation, rain, ice, and/or snow.

In the past the internal components of locks and/or latches exposed to moisture or water have corroded shortening the useful life of the lock and/or latch.

In the past ice has formed within the interior of the locks and/or latches when exposed to moisture and freezing temperatures rendering the internal components of the lock and/or latch in operable.

In the past, locks and/or latches have not provided a desired level of performance over an acceptable duration of time, which has resulted in the malfunction or failure of the lock and/or latch mechanism necessitating early replacement.

In the past, individuals have not been satisfied with the longevity of the use of locks and/or latches, and have the perceived that the lock and/or latch mechanism has failed or malfunctioned early, during the life of the lock and/or latch reducing economic value to a user.

One example of a lock and/or latch may be for use on a fuel door of a school bus or transport vehicle. It is not uncommon for these locks and/or latches to corrode or freeze, which results in the inability to open the door.

In the past, when a lock and/or latch corrodes, the detent mechanism fails to operate, whereupon the lock and/or latch will not rotate when manipulation is attempted by an individual.

In the past, in order to replace locks and/or latches, a vehicle such as a bus was removed from service for a duration of time, in order to implement required repairs. Repairs additionally increased the expense of the vehicle when considering replacement costs and labor for performance of maintenance activities.

The art referred to and/or described above is not intended to constitute an admission that any patent, publication or other information referred to herein is “prior art” with respect to this invention. In addition, this section should not be construed to mean that a search has been made or that no other pertinent information as defined in 37 C.F.R. §1.56(a) exists.

All U.S. patents and applications and all other published documents mentioned anywhere in this application are incorporated herein by reference in their entirety.

Without limiting the scope of the invention, a brief description of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided for the purposes of complying with 37 C.F.R. §1.72.

### GENERAL DESCRIPTION OF THE INVENTION

In some embodiments a grease zerk fitting which may or may not be threaded replaces a retaining screw of a latch and/or lock mechanism. Grease may then be inserted within the interior of the latch and/or lock mechanism to make the latch and/or lock mechanism water resistant. Grease within the interior of the latch and/or lock mechanism assists in the prevention of freezing when the latch and/or lock mechanism is exposed to cold weather conditions. In some embodiments, the insertion of grease into the interior of the latch and/or lock mechanism reduces corrosion and prolongs the useful life of the latch and/or lock mechanism.

In some embodiments a first aperture may be drilled into the distal end of the tumbler of the latch and/or lock in order to create a passage for grease from the grease zerk fitting into the detent hole or the interior of the tumbler.

In some embodiments the tumbler defines a longitudinal axis. In some embodiments a second aperture is placed through the exterior casing of the tumbler in a direction which is normal to the longitudinal axis. In some embodiments a first aperture is placed through an exterior end of the casing of the tumbler in a direction which is aligned with the longitudinal axis. In some embodiments a threaded tap is used to create threads in either the first or second aperture which is placed through the casing of the tumbler.

In some embodiments, the insertion of a grease zerk fitting into a latch and/or lock mechanism has applications for any device, product or equipment which is exposed to or impacted by the elements. Devices, products or equipment which include a latch and/or lock mechanism, when exposed to moisture and/or the elements may be subject to an increased risk of corrosion and malfunction of the latch and/or lock mechanism.

In some embodiments a grease zerk fitting may be incorporated into to a latch and/or lock mechanism commonly found on a fuel door of a school bus or transport vehicle. In other embodiments a grease zerk fitting may be incorporated a latch and/or lock mechanism commonly found on toolboxes, semi-trucks, buses, transport vans, boats and/or cars as well as other types of devices, equipment or vehicles.

In some embodiments the latch and/or lock mechanism is disassembled, or is provded in unassembled component parts, and a drill is used to establish a first aperture through the end of the tumbler into the detent hole or the interior of the latch and/or lock mechanism. The first aperture is smaller than the threaded aperture which is designed to hold a retaining screw. The creation of the first aperture does not adversely affect the structure of the threads for the retaining screw aperture. The first aperture is generally aligned with an axis established by the tumbler of the lock and/or latch mechanism. The latch and/or lock mechanism is then assembled or reassembled and a threaded grease zerk fitting is engaged to the threaded aperture in replacement of the retaining screw. A grease applicator may then be connected to the grease zerk fitting whereupon grease may be introduced within the detent hole or the interior of the latch and/or lock mechanism and between the tumbler and the barrel. Grease is also exposed to the detent ball and the detent spring.

In an alternative embodiment, the grease zerk fitting is not required to be threaded and may be press fit into the first aperture in the end of the tumbler.

In at least one embodiment, a second aperture is established through the exterior wall of the tumbler establishing a grease passage to or from the detent hole or the interior of the latch and/or lock mechanism. The second aperture is generally placed in a normal direction relative to the longitudinal axis of the tumbler.

In at least one embodiment if the lock and/or latch mechanism does not include a threaded aperture and a retaining screw on either the distal end or the exterior of the latch and/or lock mechanism, then a drill may be used to establish a first aperture through the distal end of the tumbler into the interior of the latch and/or lock mechanism. A tap may then be used to establish threads within the drilled passage. The passage is also generally aligned with an axis established by the tumbler of the lock and/or latch mechanism. A threaded grease zerk fitting may then be engaged to the threaded aperture.

In at least one embodiment, a second aperture may be bored from the side of the central section of the tumbler, and a tap may then be used to establish threads within bored passage. The bored passage is generally in a normal direction relative to the axis established by the tumbler of the lock and/or latch mechanism. A threaded grease zerk fitting may then be engaged to the threaded bored passage. The alternative passage may be in communication with either the detent hole or the interior of the lock and/or latch mechanism.

In an alternative embodiment, a tap is not required to be used to place threads in either the first aperture or second aperture, and a grease zerk fitting may be pressed for engagement to either one or both of the first aperture or second aperture.

In at least one embodiment, a lock and/or latch mechanism invention comprises a tumbler having a distal end, the distal end having a receiver which may be threaded and a first aperture disposed through the receiver, and a grease zerk fitting, which may have a threaded exterior portion, being engaged to the receiver, the grease zerk fitting being constructed and arranged to establish a grease passage through the grease zerk fitting into the detent hole or the interior of the tumbler.

In a first alternative embodiment, a lock and/or latch mechanism comprises a tumbler having a distal end, the distal end having a receiver which may be threaded, and a first aperture disposed through the receiver, and a grease zerk fitting which may have a threaded exterior portion being engaged to the receiver, the grease zerk fitting being constructed and arranged to establish a grease passage through the grease zerk fitting into the tumbler.

In a second alternative embodiment according to the first embodiment, the tumbler further comprises a detent hole or an interior, an exterior, a detent spring within the detent hole, and a detent ball engaged to the detent spring, the tumbler further having a second aperture, the second aperture being constructed and arranged to establish a grease passage into either the detent hole or the interior.

In a third alternative embodiment according to the second embodiment, lock and/or latch mechanism further comprises a barrel having a threaded exterior surface, the barrel being engaged to the exterior of the tumbler, a retaining nut rotatably engaged to the threaded exterior surface of the barrel, a stop engaged to the distal end of the tumbler, the stop being constructed and arranged to prevent separation of the barrel and the retaining nut from the tumbler, a latch engaged to the distal end of the tumbler, the latch being positioned to the exterior of the stop. In some embodiments at least one washer may be disposed on the distal end of the tumbler proximate to the latch.

In a fourth alternative embodiment according to the third embodiment, the tumbler comprises a handle opposite to the distal end.

In a fifth alternative embodiment according to the third embodiment, the tumbler comprises a key positioned opposite to the distal end and a lock cylinder.

In a sixth alternative embodiment according to the third embodiment, the tumbler defines a longitudinal axis.

In a seventh alternative embodiment according to the sixth embodiment, the tumbler comprises a central region, the central region having a second aperture.

In an eighth alternative embodiment according to the seventh embodiment, the aperture is positioned normal to the longitudinal axis.

In a ninth alternative embodiment according to the eighth embodiment, the second aperture is constructed and arranged to provide a grease passage.

In a tenth alternative embodiment, a lock and/or latch mechanism comprises a tumbler having a detent hole or an interior, an exterior, a detent spring within the detent hole, and a detent ball engaged to the detent spring, the tumbler further comprises a distal end having a receiver which may be threaded and a first aperture disposed through the receiver into either the detent hole or the interior, a barrel having a threaded exterior surface, the barrel being engaged to the exterior of the tumbler, a retaining nut rotatably engaged to the threaded exterior surface of the barrel, a stop engaged to the distal end, the stop being constructed and arranged to prevent separation of the barrel and the retaining nut from the tumbler, and a latch engaged to the distal end, the latch being positioned to the exterior of the stop. In at least one embodiment at least one washer may be disposed on the distal end proximate to the latch, and a grease zerk fitting, which may have a threaded exterior portion, is engaged to the threaded receiver, the grease zerk fitting being constructed and arranged to establish a grease passage through the grease zerk fitting into either the detent hole or the interior.

In an eleventh alternative embodiment according to the tenth alternative embodiment, the tumbler comprises a handle opposite to the distal end.

In a twelfth alternative embodiment according to the tenth alternative embodiment the tumbler comprises a key positioned opposite to the distal end and a lock cylinder.

In a thirteenth alternative embodiment according to the tenth alternative embodiment, the tumbler defines a longitudinal axis.

In a fourteenth alternative embodiment according to the thirteenth alternative embodiment the tumbler comprises a central region, the central region comprises a second aperture.

In a fifteenth alternative embodiment according to the fourteenth alternative embodiment the second aperture is positioned normal to the longitudinal axis.

In a sixteenth alternative embodiment according to the fifteenth alternative embodiment, the second aperture is constructed and arranged to provide a grease passage.

### BRIEF DESCRIPTION OF THE DRAWINGS

FIG. 1 depicts a side view of one alternative embodiment of the invention;

FIG. 2 depicts an exploded isometric view of one alternative embodiment of an LED light fixture as utilized with the invention;

FIG. 3 depicts a cross-sectional side view of one alternative embodiment of a the invention taken along the line 3-3 of FIG. 1;

FIG. 4 depicts a cross-sectional side view of one alternative embodiment of the invention taken along the line 3-3 of FIG. 1 following the introduction of grease within the lock and/or latch device;

FIG. 5 depicts a detailed cross-sectional side view of one alternative embodiment of the portion of the invention depicted in FIG. 4; and

FIG. 6 depicts a cross-sectional side view of one alternative embodiment of the invention taken along the line 3-3 of FIG. 1.

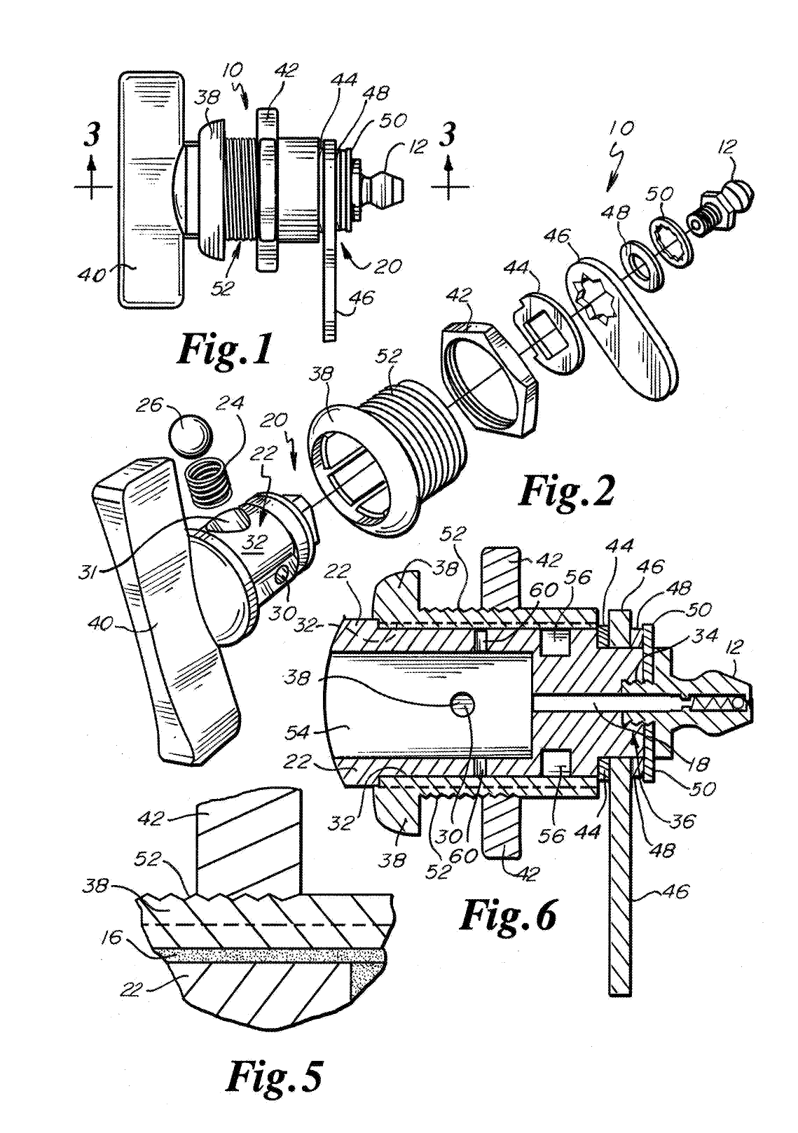

### DETAILED DESCRIPTION OF THE PREFERRED EMBODIMENTS

In some embodiments the lock and/or latch mechanism is indicated by the numeral 10. In the lock and/or latch mechanism 10 a grease zerk fitting 12 replaces a retaining screw. A grease applicator 14 may then be used to insert grease 16 within the interior of the latch and/or lock mechanism 10 to make the latch and/or lock mechanism 10 water resistant. Grease 16 within the interior of the latch and/or lock mechanism 10 assists in the prevention of freezing when the latch and/or lock mechanism 10 is exposed to cold weather conditions. In some embodiments, the insertion of grease 16 into either the detent hole 31 or the interior of the latch and/or lock mechanism 10 reduces corrosion and prolongs the useful life of the latch and/or lock mechanism 10.

In some embodiments a first aperture 18 may be drilled into the distal end 20 of the tumbler 22 to create a passage for grease 16 from the grease zerk fitting 12 into either the detent hole 31 or the interior of the tumbler 22. Grease 16 may also engage the detent spring 24 and/or detent ball 26.

In some embodiments the tumbler 22 defines a longitudinal axis 28. In some embodiments a second aperture 30 is placed through the exterior wall/casing 32 of the tumbler 22 in a direction which is normal to the longitudinal axis 28.

In some embodiments the first aperture 18 as placed through the distal end 20 of the tumbler 22 is formed in a direction which is aligned with the longitudinal axis 28. In some embodiments a threaded tap is used to create threads 34 in the first aperture 18 which is placed through the distal end 20 of the tumbler 22.

In some embodiments, the insertion of a grease zerk fitting 12 into a latch and/or lock mechanism 10 has applications for any device, product or equipment which is exposed to, or impacted by, the elements. Devices, products or equipment including a latch and/or lock mechanism 10, when exposed to moisture and/or the elements, may be subject to an increased risk of corrosion and malfunction.

In some embodiments a grease zerk fitting 12 may be incorporated into to a latch and/or lock mechanism 10 commonly found on a fuel door of a school bus or transport vehicle. In other embodiments a grease zerk fitting 12 may be incorporated a latch and/or lock mechanism 10 commonly found on toolboxes, semi-trucks, buses, transport vans, boats and/or cars as well as other types of devices, equipment or vehicles.

In some embodiments latch and/or lock mechanism 10 is provided in component parts or is disassembled prior to the drilling of the first aperture 18 for the creation of a passage through the distal end 20 of the tumbler 22. The first aperture 18 is smaller than the retaining screw receiver 36 which previously held a retaining screw. The creation of the passage does not adversely affect the structure of the threads 34 for the retaining screw receiver 36. The passage is generally aligned with the longitudinal axis 28 established by the tumbler 22 of the lock and/or latch mechanism 10. The latch and/or lock mechanism 10 is then assembled or reassembled and a grease zerk fitting 12 is engaged to the retaining screw receiver 36 in replacement of the retaining screw. A grease applicator 14 may then be connected to the grease zerk fitting 12 whereupon grease 16 may be introduced within the interior of the latch and/or lock mechanism 10 between the tumbler 22 and the barrel 38. Grease 16 is also exposed to the detent ball 26 and the detent spring 24.

In an alternative embodiment, the grease zerk fitting 12 is not required to be threaded. In addition the receiver 36 is not required to be threaded. In some embodiments, the grease zerk fitting 12 may be press fit into the receiver 36 and/or the first aperture 18.

In at least one embodiment, a second aperture 30 is placed through the exterior wall 32 of the tumbler 22 in order to establish another grease passage. The second aperture 30 is generally placed in a normal direction relative to the longitudinal axis 28 of the tumbler 22. The second aperture 30 may be in communication with either the detent hole 31 or the interior of the lock and/or latch mechanism 10.

In at least one embodiment if the lock and/or latch mechanism 10 does not include a threaded retaining screw receiver 36 and a retaining screw on the distal end 20 of the latch and/or lock mechanism 10, then a drill may be used to establish a first aperture 18 through the distal end 20 of the tumbler 22 into the interior of the latch and/or lock mechanism 10. A tap may then be used to establish threads 34 within the first aperture 18 to form the threaded retaining screw receiver 36. The first aperture 18 is also generally aligned with the longitudinal axis 28 established by the tumbler 22 of the lock and/or latch mechanism 10. A threaded grease zerk fitting 12 may then be engaged to the formed threaded retaining screw receiver 36.

In at least one embodiment, a second aperture 30 may be bored from the outside of the central section of the tumbler 22, and a tap may then be used to establish threads 34 within the second aperture 30. The second aperture 30 is generally in a normal direction relative to the longitudinal axis 28 established by the tumbler 22 of the lock and/or latch mechanism 10. A threaded grease zerk fitting 12 may then be engaged to the threaded second aperture 30.

In an alternative embodiment, a tap is not required to be used to place threads in either the first aperture 18 or the second aperture 30, and a grease zerk fitting 12 may be pressed for engagement into either one or both of the first aperture 18 and/or second aperture 30.

In at least one embodiment as depicted in FIG. 2 the lock and/or latch mechanism 10 is formed of a tumbler 22 having a handle 40 and a distal end 20. A second aperture 30 may pass through the wall/casing 32 of the tumbler 22. A detent spring 24 and detent ball 26 may be disposed in a detent hole 31 within the tumbler 22. A barrel 38 preferably surrounds the wall/casing 32 of the tumbler 22. The interior of the barrel 38 preferably engages the detent ball 26 as actuated against the interior of the barrel 38 by the detent spring 24. The exterior of the barrel 38 may include threads 52. A retaining nut 42 may be threadably engaged to the exterior threads 52 of the barrel 38. A stop 44 is preferably connected to the distal end 20 of the tumbler 22. In some embodiments the stop 44 prevents the separation of the retaining nut 42 and the barrel 38 from the exterior of the wall/casing 32 of the tumbler 22.

In some embodiments a latch 46 is engaged to the distal end 20 of the tumbler 22. The latch 46 is preferably exterior of the stop 44. A flat washer 48 may be engaged to the distal end 20 of the tumbler 22 exterior to the latch 46. A lock washer 50 may be disposed to the exterior of the flat washer 48. A threaded grease zerk fitting 12 may be threadably engaged to the threaded retaining screw receiver 36 which is interior of the distal end 20 of the tumbler 22, in order to retain the latch 46, flat washer 48, and lock washer 50 on the exterior of the distal end 20 of the tumbler 22. In some embodiments, a flat washer 48 and/or a lock washer 50 may be omitted.

In at least one embodiment, the introduction of grease 16 between the interior of the barrel 38 and the exterior of the wall/casing 22, as well as within the second aperture 30, detent hole 31, detent spring 24 and detent ball 26 minimizes the risk of corrosion inside the barrel 38 and the freezing of the detent ball 26 within the lock and/or latch mechanism 10.

In some embodiments, the latch and/or lock mechanism 10 is provided in component parts or is disassembled and the retaining screw is removed from the retaining screw receiver 36. A metal drill bit may then be selected which has a smaller diameter than the interior diameter between the threads 34 of the retaining screw receiver 36. A drill may then be used to create a first aperture 18 through the distal end 20 of the tumbler 22 along a longitudinal axis 28.

In some embodiments, a second aperture 30 may be drilled through the exterior wall/casing 32 of the tumbler 22 to form a grease passage.

In some embodiments the latch and/or lock mechanism 10 is then assembled or reassembled where the grease zerk fitting 12 is engaged to the retaining screw receiver 36 in substitution for the retaining screw.

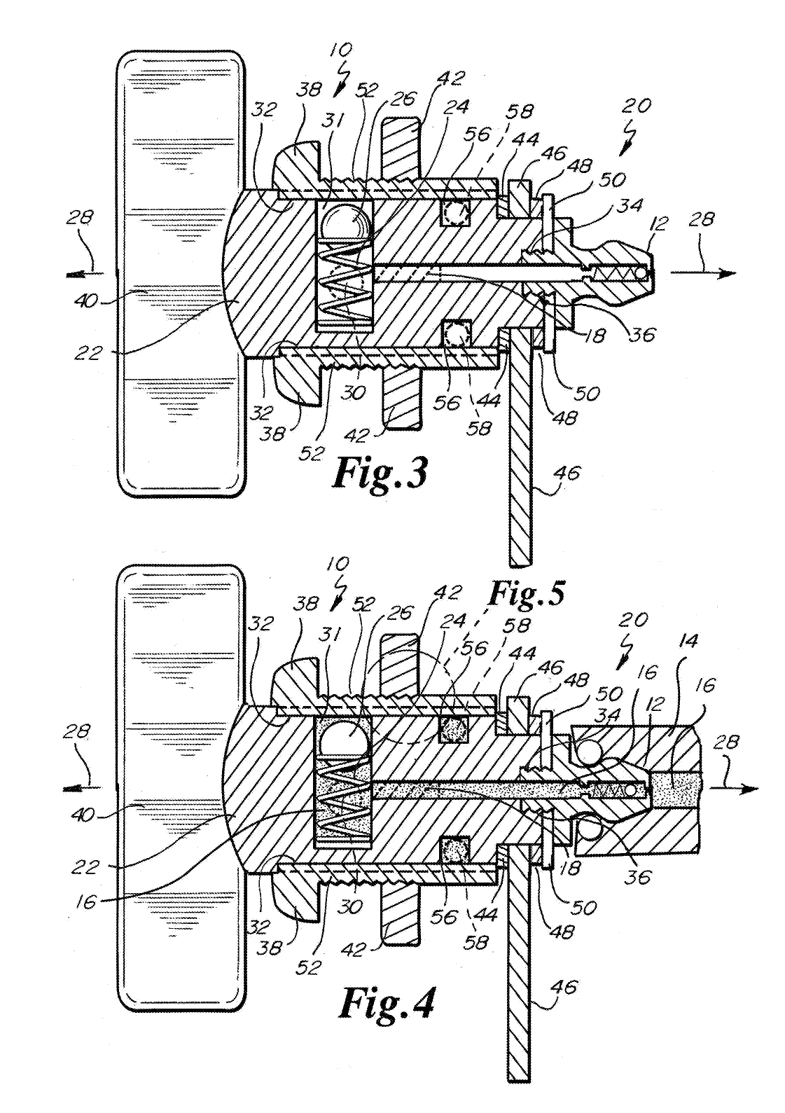

As shown in FIG. 3, in at least one embodiment the tumbler 22 includes an O-ring channel 56 which may include an O-ring 58. As seen in FIG. 3 the detent hole 31 includes the detent spring 24 and the detent ball 26. The second aperture 30 is shown in phantom line substantially perpendicular to the longitudinal axis 28 and the detent hole 31. The first aperture 18 as drilled through the casing 22 is shown proximate to and in communication with the detent hole number 31.

In some embodiments as shown in FIG. 4, grease 16 is introduced through grease zerk fitting 12 and through the first aperture 18. Grease 16 will then enter into the detent hole 31 filling the same. Grease 16 will then exit through the top of the detent hole 31 and out of the second aperture 30 in order to enter and fill the space or gap between the exterior wall/casing 32 of the tumbler 22 and the interior wall of the barrel 38 as depicted in detail in FIG. 5. The continued insertion of grease 16 through the first aperture 18 in some embodiments will also be sufficient to introduce grease into the O-ring channel 56.

In some embodiments as depicted in FIG. 6 a lock mechanism has been substituted for a latch. As depicted in FIG. 6 the lock cylinder is referred to generally by the numeral 54. In FIG. 6 the second aperture 30 preferably traverses the exterior wall/casing 32 of tumbler 22 in a direction which is normal to the longitudinal axis 28. The introduction of grease 16 into the embodiment depicted in FIG. 6 is substantially identical to the embodiments previously described related to FIG. 4 where grease 16 is introduced through the grease zerk fitting 12 for entry into the first aperture 18 and lock cylinder 54. Grease 16 will access the lock cylinder 54 through the second aperture 30. As seen in FIG. 6 second aperture 30 extends to the interior wall of the barrel 38. In some embodiments the tumbler 22 may include grease channels 60 to facilitate the passage of grease 16 outwardly from the lock cylinder 54 through the second aperture 30, and the grease channels 60 in order to fill the space or gap between the exterior wall/casing 32 of the tumbler 22 and the interior wall of the barrel 38.

In a first alternative embodiment, a lock and/or latch mechanism comprises a tumbler having a distal end, the distal end having a receiver and a first aperture disposed through the receiver, and a grease zerk fitting having an exterior portion, the exterior portion being engaged to the receiver, the grease zerk fitting being constructed and arranged to establish a grease passage through the grease zerk fitting into the tumbler.

In a second alternative embodiment according to the first embodiment, the tumbler further comprises a detent hole, an exterior, a detent spring within the detent hole, and a detent ball engaged to the detent spring, the tumbler further having a second aperture through the exterior, the second aperture being constructed and arranged to establish a grease passage from the tumbler.

In a third alternative embodiment according to the second embodiment, lock and/or latch mechanism further comprises a barrel having a threaded exterior surface, the barrel being engaged to the exterior of the tumbler, a retaining nut rotatably engaged to the threaded exterior surface of the barrel, a stop engaged to the distal end, the stop being constructed and arranged to prevent separation of the barrel and the retaining nut from the tumbler, a latch engaged to the distal end, the latch being positioned to the exterior of the stop. In some embodiments at least one washer may be disposed on the distal end proximate to the latch.

In a fourth alternative embodiment according to the third embodiment, the tumbler comprises a handle opposite to the distal end.

In a fifth alternative embodiment according to the third embodiment, the tumbler comprises a key positioned opposite to the distal end and a lock cylinder.

In a sixth alternative embodiment according to the third embodiment, the tumbler defines a longitudinal axis.

In a seventh alternative embodiment according to the sixth embodiment, the tumbler comprises a central region, the central region having a second aperture.

In an eighth alternative embodiment according to the seventh embodiment, the second aperture is positioned normal to the longitudinal axis.

In a ninth alternative embodiment according to the eighth embodiment, the second aperture is constructed and arranged to provide a grease passage.

In a tenth alternative embodiment, a lock and/or latch mechanism comprises a tumbler having a detent hole, an exterior, a detent spring within the detent hole, and a detent ball engaged to the detent spring, the tumbler further comprises a distal end having a receiver and a first aperture disposed through the receiver into the tumbler, a barrel having a threaded exterior surface, the barrel being engaged to the exterior of the tumbler, a retaining nut rotatably engaged to the threaded exterior surface of the barrel, a stop engaged to the distal end, the stop being constructed and arranged to prevent separation of the barrel and the retaining nut from the tumbler, a latch engaged to the distal end, the latch being positioned to the exterior of the stop. In some embodiments at least one washer may be disposed on the distal end proximate to the latch, and a grease zerk fitting may be engaged to the receiver, the grease zerk fitting being constructed and arranged to establish a grease passage through the grease zerk fitting into the tumbler.

In an eleventh alternative embodiment according to the tenth alternative embodiment, the tumbler comprises a handle opposite to the distal end.

In a twelfth alternative embodiment according to the tenth alternative embodiment the tumbler comprises a key positioned opposite to the distal end and a lock cylinder.

In a thirteenth alternative embodiment according to the tenth alternative embodiment, the tumbler defines a longitudinal axis.

In a fourteenth alternative embodiment according to the thirteenth alternative embodiment the tumbler comprises a central region, the central region comprises a second aperture.

In a fifteenth alternative embodiment according to the fourteenth alternative embodiment where the second aperture is positioned normal to the longitudinal axis.

In a sixteenth alternative embodiment according to the fifteenth alternative embodiment, the second aperture is constructed and arranged to provide a grease passage.

This completes the description of the preferred and alternate embodiments of the invention. Those skilled in the art may recognize other equivalents to the specific embodiment described herein which equivalents are intended to be encompassed by the claims attached hereto.

The above disclosure is intended to be illustrative and not exhaustive. This description will suggest many variations and alternatives to one of ordinary skill in this art. The various elements shown in the individual figures and described above may be combined or modified for combination as desired. All these alternatives and variations are intended to be included within the scope of the claims where the term “comprising” means “including, but not limited to”.

These and other embodiments which characterize the invention are pointed out with particularity in the claims annexed hereto and forming a part hereof However, for further understanding of the invention, its advantages and objectives obtained by its use, reference should be made to the drawings which form a further part hereof and the accompanying descriptive matter, in which there is illustrated and described embodiments of the invention.

I claim:

1. A lock and/or latch mechanism comprising:
a tumbler comprising a distal end having a receiver and a first aperture disposed through said receiver; and
a grease zerk fitting engaged to said receiver, said grease zerk fitting being constructed and arranged to establish a grease passage through said grease zerk fitting into said tumbler.

2. The lock and/or latch mechanism according to claim 1, said tumbler further comprising a detent hole, an exterior, a detent spring within said detent hole, and a detent ball engaged to said detent spring, said tumbler further comprising a second aperture through said exterior, said second aperture being constructed and arranged to establish a grease passage from said tumbler.

3. The lock and/or latch mechanism according to claim 2, said lock and/or latch mechanism further comprising;
a barrel having a threaded exterior surface, said barrel being engaged to said exterior of said tumbler;
a retaining nut rotatably engaged to said threaded exterior surface of said barrel;
a stop engaged to said distal end, said stop being constructed and arranged to prevent separation of said barrel and said retaining nut from said tumbler; and
a latch engaged to said distal end, said latch being positioned to the exterior of said stop.

4. The lock and/or latch mechanism according to claim 3, said tumbler comprising a handle opposite to said distal end.

5. The lock and/or latch mechanism according to claim 3, said tumbler comprising a key positioned opposite to said distal end and a lock cylinder.

6. The lock and/or latch mechanism according to claim 3, said tumbler defining a longitudinal axis.

7. The lock and/or latch mechanism according to claim 6, said tumbler comprising a central region, said central region comprising said second aperture.

8. The lock and/or latch mechanism according to claim 7, said second aperture being normal to said longitudinal axis.

9. A lock and/or latch mechanism comprising:
a tumbler comprising a detent hole, an exterior, a detent spring within said detent hole, and a detent ball engaged to said detent spring, said tumbler further comprising a distal end having a receiver and a first aperture disposed through said receiver into said tumbler;
a barrel having a threaded exterior surface, said barrel being engaged to said exterior of said tumbler;
a retaining nut rotatably engaged to said threaded exterior surface of said barrel;
a stop engaged to said distal end, said stop being constructed and arranged to prevent separation of said barrel and said retaining nut from said tumbler;
a latch engaged to said distal end, said latch being positioned to the exterior of said stop; and
a grease zerk fitting being engaged to said receiver, said grease zerk fitting being constructed and arranged to establish a grease passage through said grease zerk fitting into said tumbler.

10. The lock and/or latch mechanism according to claim 9, said tumbler comprising a handle opposite to said distal end.

11. The lock and/or latch mechanism according to claim 9, said tumbler comprising a key positioned opposite to said distal end and a lock cylinder.

12. The lock and/or latch mechanism according to claim 9 said tumbler defining a longitudinal axis.

13. The lock and/or latch mechanism according to claim 12, said tumbler comprising a central region, said central region comprising said second aperture.

14. The lock and/or latch mechanism according to claim 13, said second aperture being normal to said longitudinal axis.

15. The lock and/or latch mechanism according to claim 14, said second aperture being constructed and arranged to provide a grease passage.
